(19) United States
(12) Patent Application Publication
(10) Pub. No.: US 2023/0313952 A1
(43) Pub. Date: Oct. 5, 2023

(54) METHANE LEAK REMEDIATION SYSTEM AND METHOD

(71) Applicant: WEATHERFORD TECHNOLOGY HOLDINGS, LLC, HOUSTON, TX (US)

(72) Inventors: Aaron KISTLER, Houston, TX (US); Bimal VENKATESH, Houston, TX (US); Graeme MORRISON, Navan (IE)

(21) Appl. No.: 17/710,382

(22) Filed: Mar. 31, 2022

(51) Int. Cl. F17D 5/00; F17D 5/02

(52) U.S. Cl. CPC F17D 5/005; F17D 5/02

(57) ABSTRACT

A methane leak remediation system can include at least one methane sensor, equipment configured for at least one of methane production, methane transport and methane processing, and a control system configured to receive output from the methane sensor and to operate the equipment in response to the sensor output. A method of remediating a methane leak can include transmitting an output of at least one methane sensor to a control system, identifying the methane leak as represented in the sensor output, remediating the methane leak, and optimizing at least one of methane production, methane transport and methane processing. The optimizing is performed during the remediating.

### BACKGROUND

This disclosure relates generally to equipment utilized and operations performed in conjunction with activities such as methane production, transport and processing, and, in an example described below, more particularly provides for optimized leak remediation.

Releases of methane gas into the atmosphere should be avoided for at least environmental and economic reasons. Methane leaks may occur in various places. Methane production, transport and processing facilities may be especially vulnerable for methane leaks.

Therefore, it will be appreciated that improvements are continually needed in the art of identifying and mitigating methane leaks. Such improvements may be useful at methane production, transport and processing facilities, or at other types of facilities.

### BRIEF DESCRIPTION OF THE DRAWINGS

FIG. 1 is a representative partially cross-sectional view of an example of a system and associated method which can embody principles of this disclosure.

FIG. 2 is a representative schematic view of a methane leak remediation system which can embody the principles of this disclosure and may be used in the FIG. 1 system and method.

FIG. 3 is a representative flow chart for a method of remediating a methane leak which can embody the principles of this disclosure.

FIG. 4 is a representative functional diagram for the methane leak remediation system and the method of remediating a methane leak.

### DETAILED DESCRIPTION

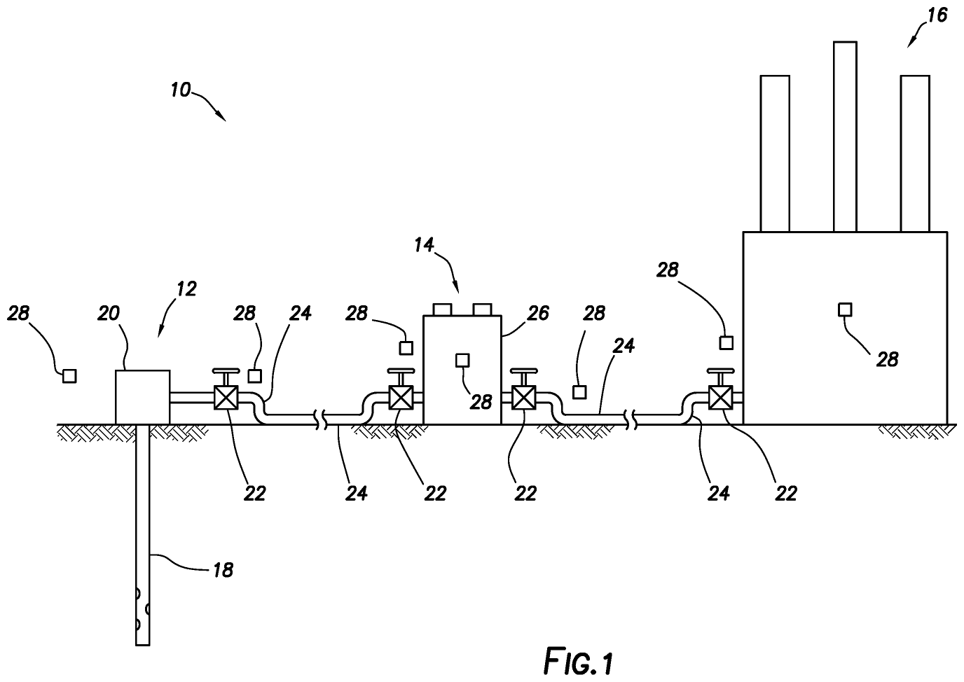

Representatively illustrated in FIG. 1 is a system 10 and associated method which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

The FIG. 1 system 10 is used to demonstrate how the principles of this disclosure can be used to reduce methane emissions in examples of production, transport and processing of hydrocarbon products (e.g., oil, gas, gas condensates, combinations of these, etc.) that include methane. In addition, methane leaks can be remediated while minimizing loss of production during the remediation.

A methane leak remediation system described below can receive input from various sensors of the production, transport or processing facilities. The sensors can include methane sensors and other types of sensors used to monitor facility operations (such as pressure, temperature, flow rate, etc., sensors). Image-based analytics and physics-based models can identify any methane leaks and their impact.

For example, methane sensors deployed at specific locations in an oilfield or along a pipeline can monitor, either continuously or periodically, the atmosphere surrounding the oilfield location or pipeline for the presence of methane gas. If methane gas above a threshold concentration or quantity is detected by a sensor, an alert is produced and the sensor data is evaluated to quantify the amount of the methane leaked. Physics-based models in combination with artificial intelligence (AI) models can use the data to estimate the quantity of methane emissions already released into the atmosphere, currently being released into the atmosphere, and a rate at which the methane will be released into the future unless mitigated.

In one example, the methane leak remediation system can include software workflows for action tracking, recording work history and economic analysis for planning and tracking the work needed to remediate a methane leak. As mentioned above, once a methane leak is detected, an alert is produced (including notifying an operator by various techniques, such as, an audible, visual or textual alarm). The alert can be transmitted by a data acquisition and communication module of the remediation system to other modules or elements of the remediation system.

An automated workflow can generate a tracking item for the leak event, which can include an analysis of all possible remediation actions and prescribe the best possible mitigation measures based on economic and operational factors of the facility. The tracking item will assign the set of actions to individuals or teams for execution in the field. The quantity of methane released (including the estimated pre-detection quantity) can be tracked from the point that the tracking item is opened until the point that the remediation is completed.

The remediation is performed in a manner that minimizes not only the quantity of methane released, but also the economic impact of the remediation. In one example, production lost due to the remediation is minimized by strategically routing production flow through the facility to thereby optimize production while the remediation is being performed. In this context, the term “production” includes production of hydrocarbons from one or more wells, transmission of hydrocarbons through pipelines, and processing of hydrocarbons, for example, in a petrochemical plant. The term “facility” is used to refer to, for example, an oilfield including one or more wells, a pipeline including compressor and terminal stations, a chemical processing plant, and any other type of facility that may be used to produce, transport or process fluids comprising methane.

The methane leak remediation system can include a surface network model which represents features (such as, valves, pipes, pumps, pressure vessels, etc.) of the facility. Different remediation scenarios can be constructed on demand or periodically using this network model. For example, options for re-routing production flow in the event of a methane leak can be examined using the network model, and the option which results in maximum production can be selected and implemented.

Implementation of the chosen option can be accomplished manually or automatically. For example, a control system could automatically operate valves, pumps, compressors or other facility equipment, as needed to maintain an optimized production during the leak remediation. Production can also be optimized after the leak is remediated using the control system, if desired.

In the FIG. 1 example, the system 10 includes three representative types of facilities 12, 14, 16 that can benefit from the principles of this disclosure. The facility 12 is an oilfield with one or more wells, each of which includes a wellbore 18, a wellhead 20 and associated equipment, such as valves 22 and pipes 24. The facility 14 is a pipeline including a compressor station 26, with associated equipment, such as valves 22, pipes 24 and pumps (not shown). The facility 16 is a chemical processing plant with associated equipment, such as valves 22, pipes 24 and pressure vessels (not shown).

The facilities 12, 14, 16 are merely examples of a wide variety of different facilities that can incorporate the principles of this disclosure. The scope of this disclosure is not limited to use of its principles with any particular type of facility.

As depicted in FIG. 1, methane sensors 28 are positioned at various locations about the facilities 12, 14, 16. Preferably, the methane sensors 28 are positioned for detection of methane releases from locations where methane is produced, stored, transmitted or processed, such as, proximate certain equipment in or through which the methane is contained. For example, at the oilfield facility 12, methane sensors 28 could be positioned proximate the wellhead 20, valve 22 and pipe 24. At the pipeline facility 14, methane sensors 28 could be positioned proximate valves 22 and pipes 24, as well as inside the compressor station 26 (such as, near pumps). At the plant facility 16, methane sensors 28 could be positioned proximate valve 22 and pipe 24, as well as inside the plant (such as, near pressure vessels). However, the scope of this disclosure is not limited to positioning methane sensors at any particular locations or proximate any particular types of equipment.

An example of a suitable methane sensor for use with the system 10 includes a camera and a spectral imaging engine to provide an image-based output that can be analyzed using the methane leak remediation system described herein to identify and quantify a methane leak. However, the scope of this disclosure is not limited to use of any particular type of methane sensor.

Other types of sensors may be used with the system 10. For example, various pressure, temperature, flow rate, etc., sensors may be used in the facilities 12, 14, 16. The methane leak remediation system can use inputs from these other sensors to assist with identifying and quantifying any methane emission, planning and tracking remediation work, and optimizing production during the remediation.

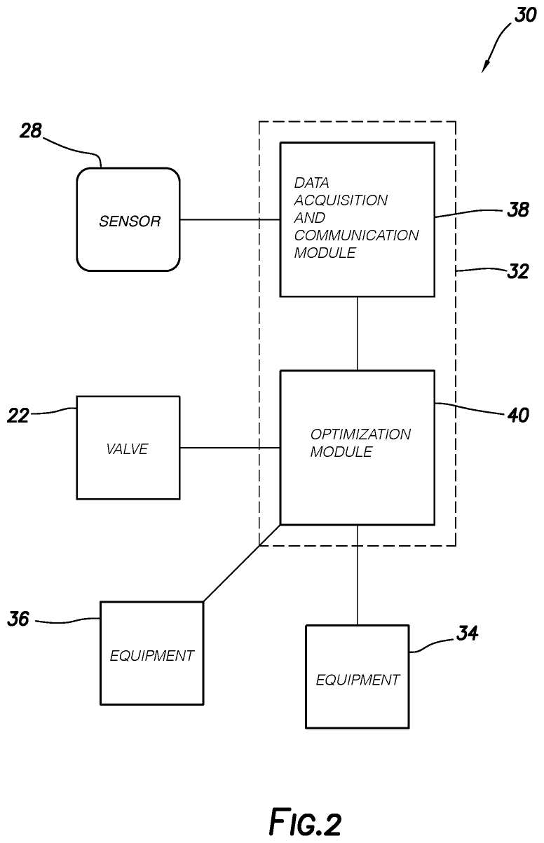

Referring additionally now to FIG. 2, a schematic view of an example of a methane leak remediation system 30 is representatively illustrated. The methane leak remediation system 30 may be used with the FIG. 1 system 10 and method, or it may be used with other systems and methods.

The remediation system 30 in this example includes a control system 32 for receiving input from the sensors 28 (and other sensors) and controlling operation of various facility equipment 22, 34, 36. The control system 32 includes a data acquisition and communication module 38 and a production optimization module 40. However, the scope of this disclosure is not limited to any particular type construction or combination of components or modules in the control system 32.

The data acquisition and communication module 38 receives data from the sensors 28 (and other sensors), stores and processes the data, and makes the data available to an operator and other modules or elements of the remediation system 30. A suitable data acquisition and communication module for use with the control system 32 would be a Supervisory Control And Data Acquisition (SCADA) Platform. The SCADA Platform would need to gather, manage and distribute data, so that the data is available and usable for operators and other components, such as the production optimization module 40.

In the FIG. 2 example, the production optimization module 40 uses the data provided by the data acquisition and communication module 38 to identify and quantify the methane emitted from the leak, plan and track the remediation work, and minimize lost production or otherwise optimize production during the remediation. Software workflows can be provided for action tracking, recording work history and economic analysis for planning and tracking the work needed to remediate a methane leak. Optimization routines can be provided for minimizing the quantity of methane released and the economic impact of the remediation. In some examples, the production optimization module 40 could be provided with suitable components, such as a device controller, to automatically operate valves, pumps, compressors or other facility equipment, as needed to maintain an optimized production during the leak remediation.

Any optimization module suitable for use with the control system would require the ability to be programmed and configured to perform the above described functions, for example, the use of physics- and AI-based models, as well as a network model for the facility.

As mentioned above, the production optimization module 40 may automatically operate various types of facility equipment. As depicted in FIG. 2, the production optimization module 40 is connected to the valve 22 and to equipment 34, 36 for operational control of the valve and other equipment. In various examples, the equipment 34, 36 could comprise one or more pumps, compressors, or other types of equipment.

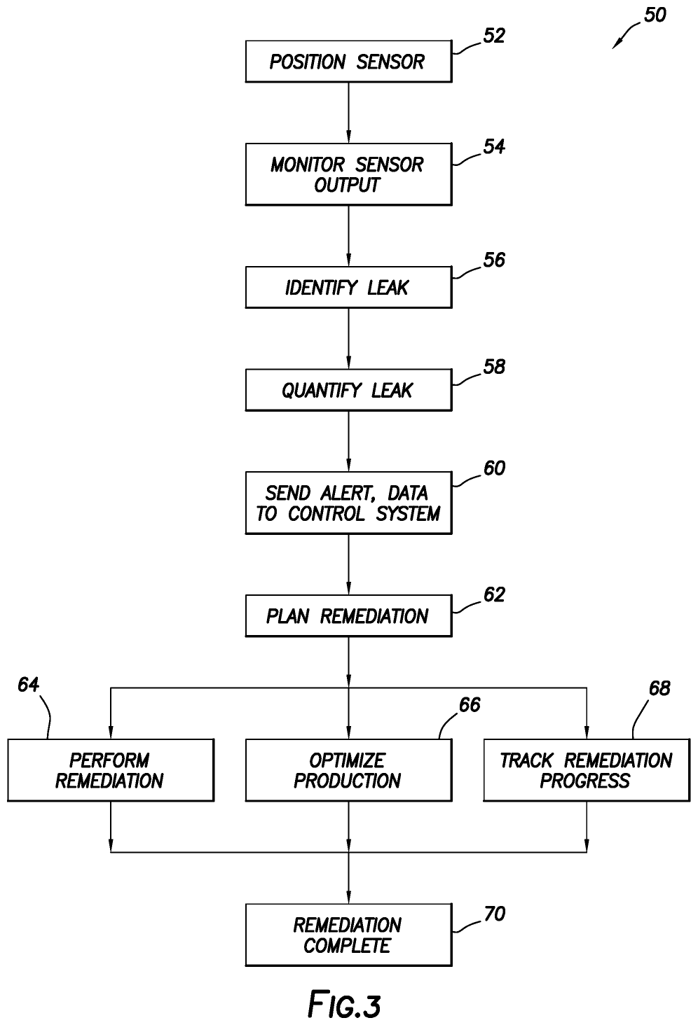

Referring additionally now to FIG. 3, a flow chart for a method 50 of remediating a methane leak is representatively illustrated. The method 50 is described below as it may be used with the methane leak remediation system 30 and method of FIG. 2. However, the method 50 may be used with other systems and methods in keeping with the scope of this disclosure.

In step 52 of the method 50, a methane sensor 28 is positioned so that it can detect a methane leak from equipment at a facility. The methane sensor 28 may be permanently or temporarily positioned. In some examples, multiple sensors 28 may be distributed about a facility.

In step 54, an output of the sensor 28 is monitored. The monitoring may be performed continuously, at periodic intervals or on demand. In the FIG. 2 example, the sensor 28 output is an input to the data acquisition and communication module 38. Outputs of other sensors (such as, pressure, temperature or flow rate sensors) may also be input to the data acquisition and communication module 38.

In step 56, a methane leak is identified as such. The identification may be a capability of the methane sensor 28, or the identification may be performed by the data acquisition and communication module 38 or the production optimization module 40. For example, suitable software, a trained neural network or an AI-based model may be provided for one of the modules 38, 40 for identifying a released methane gas in the sensor 28 output data.

In step 58, an alert and relevant data (such as, raw or processed sensor 28 output) characterizing the methane leak is communicated to the control system 32. In one example, if the identification of the methane leak occurs in the data acquisition and communication module 38, then that module 38 will transmit the alert and relevant data to the production optimization module 40. The alert and/or data may also be communicated to an on-site operator and/or to remote observers.

In step 62, remediation of the methane leak is planned. As described above, an automated workflow can generate a tracking item for the leak event, which can include an analysis of all possible remediation actions and prescribe the best possible mitigation measures based on economic and operational factors of the facility. The tracking item can assign the set of actions to individuals or teams for execution in the field. The quantity of methane released (including the estimated pre-detection quantity) can be tracked from the point that the tracking item is opened until the point that the remediation is completed.

Steps 64, 66, 68 are performed simultaneously, or at least concurrently. In step 64, the remediation work is performed. The work was previously planned (see step 62), for example, by choosing an optimal option from multiple possible options for repairing or replacing one or more items of equipment at the facility. The optimal option may be the one that results in a minimum of methane gas discharged to the atmosphere.

In step 66, production is optimized during the methane leak remediation. This step minimizes the economic impact of the methane leak and its remediation by configuring the facility (for example, by operating certain valves, pumps, compressors, etc.) so that maximum production, or minimum loss of production, is achieved during the remediation. As described above, the control system 32 may be capable of automatically controlling the facility equipment as needed to optimize production.

In step 68, the progress of the remediation work is tracked. This step can include monitoring and recording activities associated with the remediation work, as well as recording the quantity of methane released before, during and at completion of the remediation work.

In step 70, the remediation is complete. In some examples, a report may be generated for submission to governmental or regulatory agencies to account for the methane released. This information can also be provided to others as needed to review the success of the remediation work, plan future remediation work, for failure analysis, etc.

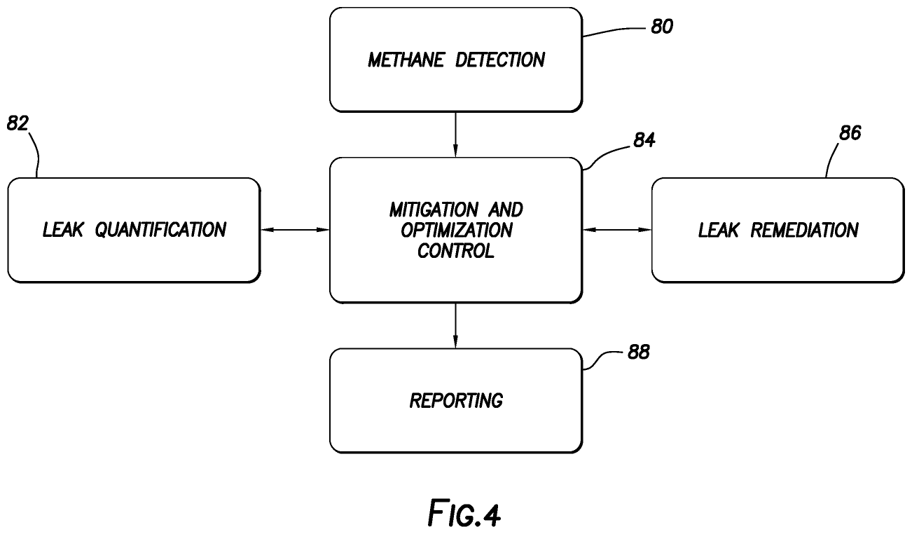

Referring additionally now to FIG. 4, an example of a functional diagram for the methane leak remediation system 30 and the method 50 of remediating a methane leak is representatively illustrated. The functions depicted in FIG. 4 are described below as they may be used with the FIG. 2 system 30 and the FIG. 3 method 50, however, they may be used with other systems and methods in keeping with the scope of this disclosure.

In functional block 80, a methane leak is detected. As described above, the methane sensor 28 can be used to detect whether methane has been released from equipment at a facility. If a methane leak is identified, relevant data about the leak (such as, date, time, sensor output, etc.) is recorded, an alert or alarm is communicated to an operator and one or more elements of the control system 32. The facility equipment from which the methane leak originates can also be identified.

In functional blocks 82, 84, 86, the functions of leak quantification, mitigation and optimization, and leak remediation are performed, generally from the time the leak is detected to the time the leak is remediated. In block 82, the leak volume can be calculated or estimated from the time the leak originated to the time the leak was detected or the alert was communicated, from the time the leak was detected or the alert was communicated to the current time, and from the current time to the time the leak will be remediated. A forecast of daily leak volume from the time the leak was detected or the alert was communicated may also be provided.

In block 84, the alert is processed and a tracking item is created. A remediation workflow is created for mitigating the leak. The remediation work is performed, some of which may be automatically performed and/or remotely controlled. During the remediation work, production can be optimized and the remediation work can be evaluated to determine whether further remediation is needed. An economic analysis can be performed to analyze the cost of the remediation work, the cost of any lost production and the total versus forecast leak volume.

In block 86, the leak remediation work is performed. The work is performed according to the remediation plan produced after the methane leak was identified. Progress of the work is monitored, and the plan may be changed or further optimized based on the progress. During the remediation work, production is optimized, for example, using the production optimization module 40.

In block 88, upon completion of the remediation work, one or more reports can be produced. The reports may detail, for example, the total volume of methane released, any production lost due to the leak, production achieved due to optimization, and/or a greenhouse gas footprint estimate. The reports may be distributed internally (within a company) or externally (e.g., to third parties, governmental or regulatory agencies, etc.).

It may now be fully appreciated that the above disclosure provides significant advancements to the art of detecting and mitigating releases of methane gas. In examples described above, the system 30 can be effectively utilized to remediate a methane leak, while optimizing production during the remediation work.

In one aspect, the above disclosure provides to the art a methane leak remediation system 30. In one example, the methane leak remediation system 30 can include at least one methane sensor 28, equipment 22, 24, 34, 36 configured for at least one of the group consisting of methane production, methane transport and methane processing, and a control system 32 configured to receive output from the methane sensor 28 and to operate the equipment 22, 24, 34, 36 in response to the sensor output.

The control system 32 may comprise a production optimization module 40. The production optimization module 40 may be configured to operate the equipment 22, 24, 34, 36 automatically in response to the sensor output.

The production optimization module 40 may be configured to minimize lost production due to leak remediation. The production optimization module 40 may be configured to optimize the methane production, methane transport and/or methane processing.

The control system 32 may comprise a data acquisition and communication module 38. The data acquisition and communication module 38 may be configured to identify a methane leak represented in the sensor 28 output. The data acquisition and communication module 38 may be configured to determine a quantity of leaked methane represented in the sensor 28 output.

The data acquisition and communication module 38 may be configured to communicate an alert to the production optimization module 40 upon identification of the methane leak. The production optimization module 40 may be configured to automatically generate a workflow for remediation of the methane leak upon communication of the alert to the production optimization module 40.

Also provided to the art by the above disclosure is a method 50 of remediating a methane leak. In one example, the method 50 can include: transmitting an output of at least one methane sensor 28 to a control system 32; identifying the methane leak as represented in the sensor 28 output; remediating the methane leak; and optimizing at least one of methane production, methane transport and methane processing. The optimizing step is performed is performed during the remediating step.

The methane leak may be from an equipment 22, 24, 34, 36 configured for the methane production, methane transport and/or methane processing, and the method 50 can include positioning the methane sensor 28 an operational distance from the equipment 22, 24, 34, 36. The operational distance is within a methane sensing range of the methane sensor 28.

The optimizing step can include minimizing lost production due to the remediating step. The optimizing step may be performed automatically during the remediating step.

The identifying step can include identifying a source of the methane leak, and the remediating step can include automatically planning a workflow for repair or replacement of the source of the methane leak. The planning step can include selecting the workflow with a minimum of lost production during the remediating step.

The method 50 can include automatically sending an alert in response to the identifying step. The method 50 may include automatically determining a quantity of the methane leak in response to the alert sending step and during the remediating step.

The methane sensor 28 may comprise multiple methane sensors 28 distributed about a methane facility 12, 14, 16, and the optimizing step may comprise optimizing the methane production, methane transport and/or methane processing at the methane facility 12, 14, 16. The remediating step may include the control system 32 automatically operating equipment 22, 24, 34, 36 of the methane facility 12, 14, 16.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various configurations, without departing from the principles of this disclosure. The embodiments are described merely as examples of useful applications of the principles of the disclosure, which is not limited to any specific details of these embodiments.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A methane leak remediation system, comprising:
at least one methane sensor; and
a control system configured to receive output from the methane sensor and to operate equipment in response to the sensor output.

2. The methane leak remediation system of claim 1, in which the control system comprises an optimization module.

3. The methane leak remediation system of claim 2, in which the optimization module is configured to operate the equipment automatically in response to the sensor output.

4. The methane leak remediation system of claim 2, in which the optimization module is configured to minimize lost production due to leak remediation.

5. The methane leak remediation system of claim 2, in which the optimization module is configured to optimize at least one of the group consisting of methane production, methane transport and methane processing.

6. The methane leak remediation system of claim 1, in which the control system comprises a data acquisition and communication module.

7. The methane leak remediation system of claim 6, in which the data acquisition and communication module is configured to identify a methane leak represented in the sensor output.

8. The methane leak remediation system of claim 7, in which the control system further comprises an optimization module, and the data acquisition and communication module is configured to communicate an alert to the optimization module upon identification of the methane leak.

9. The methane leak remediation system of claim 8, in which the optimization module is configured to automatically generate a workflow for remediation of the methane leak upon communication of the alert to the optimization module.

10. The methane leak remediation system of claim 6, in which the data acquisition and communication module is configured to determine a quantity of leaked methane represented in the sensor output.

11. A method of remediating a methane leak, the method comprising:
transmitting an output of at least one methane sensor to a control system;
identifying the methane leak as represented in the sensor output;
remediating the methane leak; and
optimizing at least one of the group consisting of methane production, methane transport and methane processing,
in which the optimizing is performed during the remediating.

12. The method of claim 11, in which the methane leak is from an equipment configured for the at least one of the group consisting of methane production, methane transport and methane processing, and further comprising positioning the methane sensor an operational distance from the equipment, the operational distance being within a methane sensing range of the methane sensor.

13. The method of claim 11, in which the optimizing comprises minimizing lost production due to the remediating.

14. The method of claim 11, in which the optimizing is performed automatically during the remediating.

15. The method of claim 11, in which the identifying comprises identifying a source of the methane leak, and in which the remediating comprises automatically planning a workflow for repair or replacement of the source of the methane leak.

16. The method of claim 15, in which the planning comprises selecting the workflow with a minimum of lost production during the remediating.

17. The method of claim 11, further comprising automatically sending an alert in response to the identifying.

18. The method of claim 17, further comprising automatically determining a quantity of the methane leak in response to the alert sending and during the remediating.

19. The method of claim 11, in which the at least one methane sensor comprises multiple methane sensors distributed about a methane facility, and in which the optimizing comprises optimizing the at least one of the group consisting of methane production, methane transport and methane processing at the methane facility.

20. The method of claim 19, in which the remediating comprises the control system automatically operating equipment of the methane facility.
